(19) United States
(12) Patent Application Publication
(10) Pub. No.: US 2021/0167455 A1
(43) Pub. Date: Jun. 3, 2021

(54) BATTERY MODULE AND METHOD FOR MANUFACTURING SAME

(71) Applicant: Panasonic Intellectual Property Management Co., Ltd., Osaka (JP)

(72) Inventors: Oose OKUTANI, Hyogo (JP); Shinichi SAKAMOTO, Osaka (JP)

(21) Appl. No.: 17/175,411

(22) Filed: Feb. 12, 2021

Related U.S. Application Data
(62) Division of application No. 16/479,409, filed on Jul. 19, 2019.

(30) Foreign Application Priority Data
Jan. 31, 2017 (JP) 2017-015070

(51) Int. Cl. H01M 50/213; B23K 20/10; H01M 50/10; H01M 50/502; H01M 50/543

(52) U.S. Cl. CPC H01M 50/213; B23K 20/10; H01M 50/543; H01M 50/502; H01M 50/10

(57) ABSTRACT

A battery module includes a plurality of battery cells each having a terminal, and a lead plate having a lead part each of which is joined to the terminal of each of the battery cells to electrically connect the battery cells to each other. The lead part includes an aluminum thin plate having aluminum purity higher than or equal to 99.0%. Surface roughness Ra of a joining surface of the lead part to the terminal is less than or equal to 10 μm. The lead part is electrically connected to the terminal by solid-phase bonding.

### CROSS-REFERENCE TO RELATED APPLICATIONS

This application is a divisional of U.S. application Ser. No. 16/479,409, filed Jul. 19, 2019, which is a U.S. national stage application of the PCT International Application No. PCT/JP2018/001099 filed on Jan. 17, 2018, which claims the benefit of foreign priority of Japanese patent application 2017-015070 filed on Jan. 31, 2017, respectively, the contents all of which are incorporated herein by reference.

### TECHNICAL FIELD

The present disclosure relates to a battery module and a method for manufacturing the battery module.

### BACKGROUND ART

Conventionally, a battery module configured of a plurality of battery cells electrically connected by a lead plate has been known. As a battery cell, a secondary battery such as a lithium ion battery or a nickel hydride battery is preferably used. As a lead plate, a nickel thin plate or a copper thin plate is used. Besides it, for example, an aluminum thin plate may be used in consideration of weight, heating by a current flow, cost, and the like.

A lead plate has a plurality of lead parts corresponding to the respective battery cells. For example, a lead part can be formed in a piece shape connected with the base plate of the lead plate in a cantilever state by means of punching applied to an aluminum thin plate in a plate shape. When the lead part formed as described above is connected to each of the terminals of the battery cells, each battery cell is electrically connected via the lead plate.

In the case where a terminal of a battery cell is configured of a plate material made of aluminum or aluminum alloy, metallurgical bonding can be made by applying spot welding to the lead part of the lead plate formed of an aluminum thin plate of a same type. However, in the case where a terminal of a battery cell is made of a material other than aluminum such as copper, copper alloy, or iron-based metal, since aluminum does not form an alloy layer with copper or iron, metallurgical bonding cannot be made. Further, when a lead plate is joined to a battery cell by metallurgical bonding such as spot welding, it is concerned that heat at the time of welding may be conducted to an electrode inside the battery cell via a terminal, and consequently an electrode material (such as active substance) may be degraded by the influence of the heat so that the battery performance may be lowered.

Recently, as a technology of joining different types of metal to each other, solid-phase bonding is widely used. For example, PTL 1 describes an assembled battery in which a metal line is connected to metal terminals of a plurality of unit cells adjacent to each other to thereby connect the unit cells in series or in parallel by the metal line. The metal line is connected by ultrasonic welding to a joining surface of a metal terminal of each unit cell.

### CITATION LIST

### Patent Literature

PTL 1: Japanese Patent No. 5078282

### SUMMARY OF THE INVENTION

PTL 1 describes that a metal line formed of a metal body is layered on a metal terminal of a unit cell, and in a state where the metal line is pressed onto the metal terminal, the metal line is applied with ultrasonic vibration so as to be welded to the metal terminal by ultrasonic welding. Pressing force, vibration frequency, and power of an ultrasonic vibrator at the time of pressing and vibrating the metal line are illustrated with specific numerical values.

However, in the case of joining a lead plate to a terminal of a battery cell by solid-phase bonding as described above, it is preferable to improve the reliability of a battery module due to an increase in joining strength of the lead plate and to improve productivity due to reduction of the joining time, by thinking out parameters other than welding process conditions of an ultrasonic welding machine.

An object of the present disclosure is to improve reliability of a battery module by firmly joining a lead plate formed of an aluminum thin plate to terminals of battery cells, and to improve productivity of the battery module by reduction of joining time, through parameter adjustment other than process conditions of ultrasonic welding.

A battery module according to the present disclosure is a battery module including a plurality of battery cells each having a terminal, and a lead plate having a lead part to be joined to the terminal of each of the battery cells to electrically connect the battery cells to each other. The lead part includes an aluminum thin plate having aluminum purity higher than or equal to 99.0%. Surface roughness Ra of a joining surface of the lead part to the terminal is less than or equal to 10 μm. The lead part is electrically connected to the terminal by solid-phase bonding.

Further, a method of manufacturing a battery module, according to the present disclosure, is a method of manufacturing a battery module that includes a plurality of battery cells each having a terminal, and a lead plate having a lead part joined to the terminal of each of the plurality of battery cells to electrically connect the battery cells to each other, the lead part being connected to the terminal by solid-phase bonding through ultrasonic joining. The method includes a preparing step of preparing the plurality of the battery cells and the lead plate, the lead part of the lead plate including an aluminum thin plate having aluminum purity higher than or equal to 99.0%, a surface roughness Ra of a joining surface of the lead part to the terminal being less than or equal to 10 μm; a pressing step of pressing the joining surface of the lead part to the terminal of one of the battery cells by an ultrasonic vibrator; a vibration step of vibrating the lead part with use of the ultrasonic vibrator; and a heating step of heating at least the lead part in the lead plate. Here, the pressing step, the vibration step, and the heating step may be performed simultaneously.

According to a battery module and a method for manufacturing the battery module according to the present disclosure, a lead plate formed of an aluminum thin plate can be firmly joined to terminals of battery cells through solid-phase bonding even between different types of metals, reliability of the battery module is improved, and productivity of the battery module is improved by reduction of bonding time.

### BRIEF DESCRIPTION OF DRAWINGS

FIG. 1 is an exploded perspective view of a battery module according to an embodiment.

FIG. 2A is an enlarged plan view of a lead part of a lead plate joined to a terminal of a battery cell by solid-phase bonding, and FIG. 2B is a cross-sectional view taken along IIB-IIB of FIG. 2A.

FIGS. 3A to 3C are views similar to FIG. 2A, showing a modification of a shape of a lead part.

FIG. 4 shows a state where a lead part of a lead plate is joined to a terminal of a battery cell by ultrasonic joining.

FIG. 5 is a flowchart showing steps of manufacturing a battery module by joining a lead part of a lead plate to a terminal of a battery cell through ultrasonic joining.

### DESCRIPTION OF EMBODIMENT

An exemplary embodiment of the present invention will now be described in detail with reference to the attached drawings. In the following description, specific shapes, materials, numerical values, directions, and other elements are examples shown to facilitate understanding of the present invention and may be changed as appropriate to suit uses, purposes, specifications, or other requirements. It is initially envisaged that when exemplary embodiments and modifications are included in the following description, some distinctive elements in the exemplary embodiments and the modifications are suitably combined and used.

Hereinafter, description will be given of a case where a battery cell is a cylindrical battery. However, the present disclosure may be applied to a battery module configured of a plurality of square-shaped battery cells connected with each other. Further, in the below description, a term “ultrasonic joining” is appropriately used instead of a typical term “ultrasonic welding”, in order to clearly distinguish it from metallurgical bonding such as spot welding.

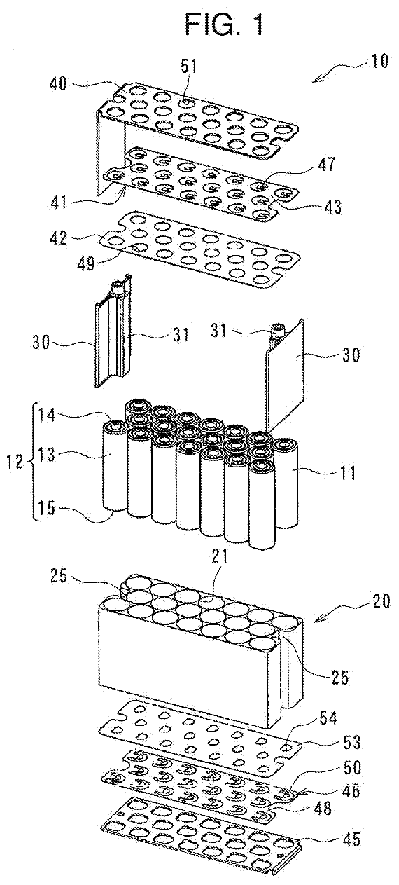

FIG. 1 is an exploded perspective view of battery module 10 according to an exemplary embodiment of the present disclosure. First, with reference to FIG. 1, an overview of battery module 10 will be described. As shown in FIG. 1, battery module 10 includes a plurality of cylindrical battery cells 11 and battery holder 20 having a plurality of cylindrical containers to hold battery cells 11.

Battery cell 11 includes cell case 12 made of metal, a battery element (not shown) contained in cell case 12, positive-electrode terminal 14, and negative-electrode terminal 15. The battery element includes a pair of electrode assemblies, a non-aqueous electrolyte that allows transfer of electric charges, and the like. Cell case 12 is configured of cell case body 13 that is formed in a bottomed cylindrical shape to contain the battery element, and a sealing body that seals an opening of cell case body 13. The sealing body constitutes positive-electrode terminal 14 that protrudes in a flat columnar shape, for example, at one end of battery cell 11. A gasket (not shown) made of resin is disposed between cell case body 13 and positive-electrode terminal 14.

Positive-electrode terminal 14 has a layered or stacked structure including a valve, a cap, and the like, and is electrically connected to a positive-electrode assembly of the battery element. In the present embodiment, positive-electrode terminal 14 may be formed of an aluminum plate or an aluminum alloy plate, or may be formed of a metal plate made of copper, copper alloy, iron-based metal, or the like. Cell case body 13 is electrically connected with a negative-electrode assembly of the battery element and functions as a negative electrode of battery cell 11. In general, however, an outer peripheral side surface of cell case body 13 is covered with an insulating resin film and a circular flat bottom surface of cell case body 13 serves as negative-electrode terminal 15. In the present embodiment, cell case body 13 constituting negative-electrode terminal 15 may be formed of an aluminum plate or an aluminum alloy plate, or may be formed of a metal plate made of copper, copper alloy, iron-based metal, or the like.

Battery cell 11 is contained in hole 21 of each cylindrical container of battery holder 20, and is arranged in an array. Battery module 10 includes a pair of posts 30 attached to battery holder 20. Posts 30 are plate-shaped members that cover both lateral faces of battery holder 20. Each post 30 has protrusion 31 on one surface. Posts 30 are disposed so as to face each other over battery holder 20, with protrusions 31 facing battery holder 20. Protrusions 31 are fitted into recesses 25 of battery holder 20.

Positive-electrode lead plate (lead plate) 41 is disposed above battery holder 20 via positive-electrode insulation board 42 in a state of being electrically connected to positive-electrode terminals 14 of battery cells 11. Positive-electrode current collector plate 40 is disposed above positive-electrode lead plate 41 in a state of being electrically connected to positive-electrode lead plate 41. Positive-electrode lead plate 41 and positive-electrode current collector plate 40 are integrated with each other by welding or the like, for example.

Meanwhile, negative-electrode lead plate (lead plate) 46 is disposed below battery holder 20 via negative-electrode insulation board 53 in a state of being electrically connected to negative-electrode terminals 15 of battery cells 11. Negative-electrode current collector plate 45 is disposed below negative-electrode lead plate 46 in a state of being electrically connected to negative-electrode lead plate 46. Negative-electrode lead plate 46 and negative-electrode current collector plate 45 are integrated with each other by welding or the like, for example.

Battery cells 11 are connected in parallel with each other by positive-electrode lead plate 41 and negative-electrode lead plate 46. Positive-electrode lead plate 41 includes positive-electrode base plate (base plate) 43 and positive-electrode lead parts (lead parts) 47. Positive-electrode lead parts 47 are formed in a number corresponding to a number of battery cells 11 included in battery module 10. Positive-electrode base plate 43 is electrically connected to positive-electrode terminals 14 of battery cells 11 via positive-electrode lead parts 47.

Negative-electrode lead plate 46 includes negative-electrode base plate (base plate) 48 and negative-electrode lead parts (lead parts) 50. Negative-electrode lead parts 50 are formed in a number corresponding to a number of battery cells 11 included in battery module 10. Negative-electrode base plate 48 is electrically connected to negative-electrode terminals 15 of battery cells 11 via negative-electrode lead parts 50.

Positive-electrode insulation board 42 is disposed between battery holder 20 and positive lead plates 41, positive-electrode insulation board 42 having circular holes 49 to expose terminals 14 of battery cells 11. Negative-electrode insulation board 53 is disposed between battery holder 20 and negative-electrode lead plates 46, negative-electrode insulation board 53 having circular holes 54 to expose terminals 15 of battery cells 11. Each of positive-electrode insulation board 42 and negative-electrode insulation board 53 is configured of a resin board material, for example. Each of circular holes 49, 54 is formed to have a larger diameter than that of positive-electrode terminal 14 and have a smaller diameter than that of cylindrical cell case body 13.

Positive-electrode current collector plate 40, positive-electrode insulation board 42, and other components are fixed to the pair of posts 30 using screws (not shown), for example. Negative-electrode current collector plate 45 and negative-electrode insulation board 53 are also fixed to the pair of posts 30 using screws (not shown), for example. Thereby, battery module 10 is integrally assembled. The battery module integrated in this way is connected in series to another battery module 10 adjacently disposed, via, for example, positive-electrode current collector plate 40 and negative-electrode current collector plate 45.

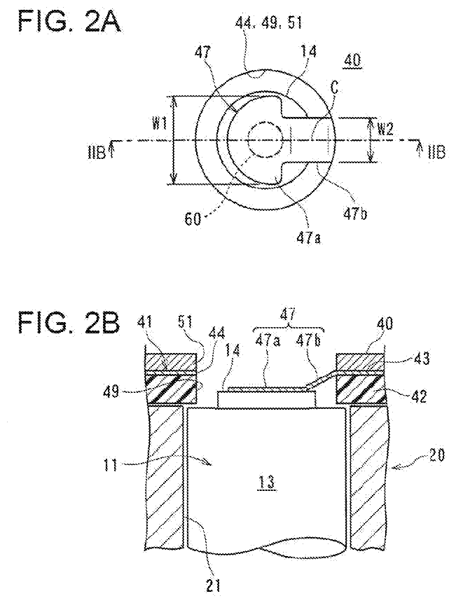

FIG. 2A is an enlarged plan view of a lead part of a positive-electrode lead plate joined to positive-electrode terminal 14 of battery cell 11 by solid-phase bonding, and FIG. 2B is a cross-sectional view taken along IIB-IIB of FIG. 2A.

As shown in FIGS. 2A and 2B, in positive-electrode lead plate 41, positive-electrode lead part 47 is formed as a piece connected with base plate 43 in a cantilever shape by forming through hole 44 in an almost U shape by applying punching to an aluminum thin plate, for example. For example, positive-electrode lead part 47 includes lead tip 47a in an almost circular shape, and lead neck 47b that connects lead tip 47a and base plate 43. In the present embodiment, lead neck 47b is bent at a base end side close to base plate 43 so as to be inclined obliquely and is bent near lead tip 47a such that lead tip 47a takes a posture along base plate 43.

Maximum width W1 of lead tip 47a is preferably formed to be larger than width W2 (for example, between 0.15 mm and 2 mm, inclusive) of lead neck 47b in a range from 1.0 time to 10 times, approximately, and more preferably, formed to be larger in a range from 2 times to 5 times, approximately. In other words, width W2 of lead neck 47b is preferably formed to have a value approximately ranging from a same value to 1/10 of maximum width W1 of lead tip 47a, and more preferably, formed to have a value approximately ranging from ½ to ⅕. By narrowing width W2 of lead neck 47b as described above, in the case of joining positive-electrode lead part 47 to positive-electrode terminal 14 by ultrasonic joining as described above, lead tip 47a easily vibrates, and ultrasonic joining can be performed in a good condition in a short time.

Further, for example, plate thickness t of positive-electrode lead plate 41 integrally having lead tip 47a is preferably between 0.05 mm and 0.5 mm (inclusive), and more preferably, less than or equal to 0.3 mm. Furthermore, it is preferable that lead tip 47a is formed to be wider than lead neck 47b. In particular, it is preferable that lead tip 47a is formed in a symmetrical shape with respect to center line C in a lateral direction of lead neck 47b. When lead tip 47a is formed in a symmetrical shape as described above, lead tip 47a easily vibrates. Therefore, it is advantageous in performing ultrasonic joining in a good condition in a short time.

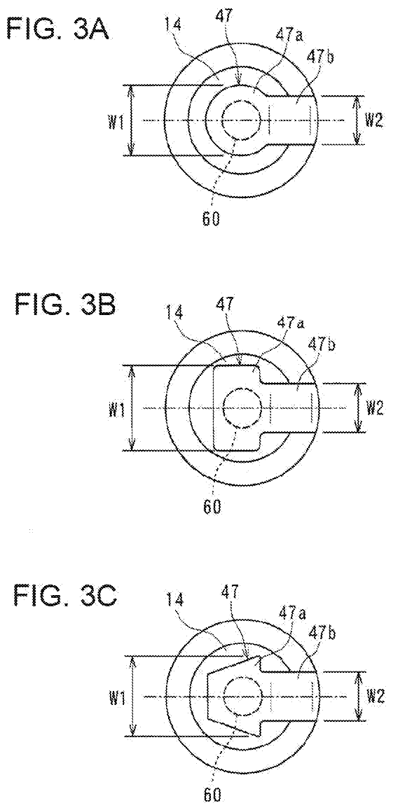

Note that the shape of lead tip 47a is not limited to the aforementioned semicircular shape. For example, lead tip 47a may be formed in an almost circular shape as shown in FIG. 3A, or in an almost rectangular shape as shown in FIG. 3B, or in an almost trapezoidal shape as shown in FIG. 3C.

Moreover, lead neck 47b of positive-electrode lead part 47 may have width W2 for example, and may be formed to have a narrow width that is about 1/10 of width W1 of lead tip 47a to function as a fuse. In that case, when overcurrent flows due to an internal short circuit or the like of battery cell 11, by fusing lead neck 47b, it is possible to electrically cut off battery cell 11 so as to prevent other battery cells 11 from being affected.

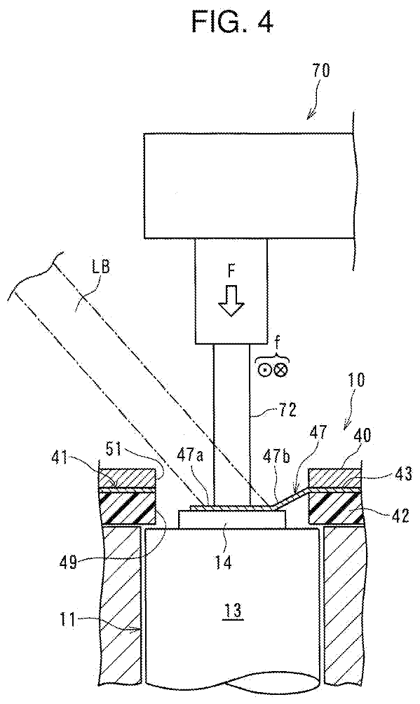

As shown in FIG. 2A, positive-electrode lead part 47 is joined to the surface of positive-electrode terminal 14 by ultrasonic joining at a center of lead tip 47a. Joining portion 60 is illustrated as a circular region of a two dot chain line. Next, ultrasonic joining of positive-electrode lead part 47 to positive-electrode terminal 14 of battery cell 11 will be described with reference to FIG. 4.

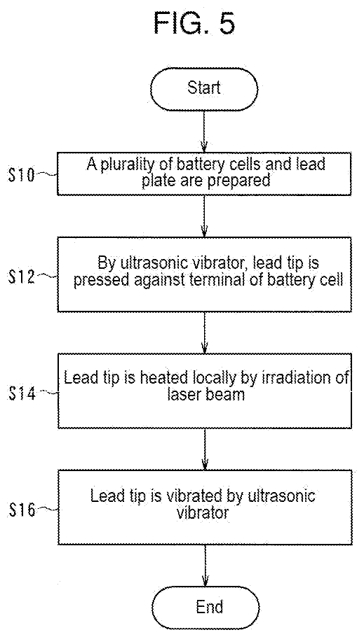

FIG. 4 shows a state where positive-electrode lead part 47 of positive-electrode lead plate 41 is joined to positive-electrode terminal 14 of battery cell 11 by ultrasonic joining. FIG. 5 is a flowchart showing steps of manufacturing battery module 10 by joining positive-electrode lead part 47 of positive-electrode lead plate 41 to positive-electrode terminal 14 of battery cell 11 through ultrasonic joining.

As shown in FIG. 4, in the present embodiment, positive-electrode lead part 47 is joined to positive-electrode terminal 14 by using ultrasonic welding machine 70 having columnar ultrasonic vibrator 72, for example. In the present embodiment, cell case body 13 of battery cell 11, in the case of being configured of an iron-based metal plate, is illustrated as an example. Positive-electrode terminal 14 of battery cell 11 is configured of an iron-based metal plate. Positive-electrode lead part 47 is configured of an aluminum thin plate having aluminum purity higher than or equal to 99.0%. It is preferable that positive-electrode lead part 47 is configured of an aluminum thin plate having aluminum purity higher than or equal to 99.5% (corresponding to JIS standard: A1050). The surface roughness of the joining surface of positive-electrode lead part 47 to be joined to the surface of positive-electrode terminal 14 is less than or equal to Ra10 μm, and more preferably, less than or equal to Ra1 μm.

The purity and surface roughness of positive-electrode lead part 47 as described above are realized by using an aluminum thin plate having such purity and surface roughness as described above, as positive-electrode lead plate 41. By using an aluminum thin plate having high purity and less additives and impurities as described above, it is advantageous in reducing the inter-atom distance between an atom of a metallic material constituting positive-electrode terminal 14 and an aluminum atom of positive-electrode lead part 47. Thereby, strong solid-phase bonding (eutectic state) can be realized.

In the case of joining positive-electrode lead plate 41 to battery cell 11 by ultrasonic joining, first, a plurality of battery cells 11 and positive-electrode lead plate 41 are prepared (step S10 of FIG. 5). In addition, positive-electrode insulation board 42 is also prepared in the present embodiment. In the present embodiment, the case where positive-electrode lead plate 41 is previously integrated with positive-electrode current collector plate 40 by welding or the like is shown as an example. However, it is also acceptable that after positive-electrode lead plate 41 is joined to battery cell 11 by ultrasonic joining, positive-electrode lead plate 41 may be welded with positive-electrode current collector plate 40 to be integrated.

Next, battery cell 11 is set on a support table (not shown) of ultrasonic welding machine 70. Then, a state in which battery cell 11 is overlaid with positive-electrode insulation board 42, positive-electrode lead plate 41, and positive-electrode current collector plate 40 is set. At this time, positive-electrode terminal 14 of battery cell 11 is in a state of being exposed via holes 49, 51 of positive-electrode insulation board 42 and positive-electrode current collector plate 40, and lead tip 47a of positive-electrode lead part 47 faces or is laid on the surface of positive-electrode terminal 14.

In this state, by ultrasonic vibrator 72, lead tip 47a is pressed against positive-electrode terminal 14 with pressing force F between 1 N and 50 N (inclusive), for example, and more preferably, between 10 N and 35 N (inclusive) (step S12 of FIG. 5).

Then, in the present embodiment, lead tip 47a, pressed by ultrasonic vibrator 72, is irradiated with laser beam LB. Thereby, lead tip 47a is heated locally, rather than the entire positive-electrode lead plate 41 (step S14 of FIG. 5). The laser wavelength of laser beam LB at this time is between 300 nm and 1100 nm (inclusive), for example (more preferably, between 800 nm and 1100 nm, (inclusive)), and the laser power may be between 100 W and 5000 W (inclusive), for example. With the local heating as described above, when lead tip 47a is joined by ultrasonic joining under a room temperature environment, temperature rise on the boundary surface between lead tip 47a and positive-electrode terminal 14 is accelerated. Therefore, it is advantageous in realizing a solid-phase state in a shorter time.

Here, it is confirmed that in the local heating by laser beam LB, in the case where a temperature rise approximately ranging from 20° C. to 50° C. is achieved, for example, joining strength of lead tip 47a is increased in a range from 5% to 10% approximately. With the configuration of heating locally by laser beam LB as described above, downsizing and cost reduction of manufacturing facility of battery module 10 can be realized. To heat lead tip 47a from the outside, it is conceivable to spray hot air by a nozzle at a spot or perform ultrasonic joining in a high-temperature tank. In that case, however, battery module constituent members (for example, battery cell 11) other than lead tip 47a, not related to solid-phase bonding, may also be heated and affected by the heat (for example, degradation of electrode material or resin packing, or the like). Therefore, it is preferable to use local heating by irradiation of laser beam.

Next, in the pressing state and the local heating state, for example, ultrasonic vibrator 72 is vibrated with vibration frequency f ranging from 60 kHz to 100 kHz, and more preferably, from 70 kHz to 90 kHz to vibrate lead tip 47a (step S16). For example, the power of ultrasonic welding machine 70 at that time may range from 5 W to 300 W, and more preferably, from 40 W to 80 W.

Thereby, the temperature of lead tip 47a rises by the friction heat with positive-electrode terminal 14, and lead tip 47a is softened. The temperature of the joining surface of lead tip 47a (that is, a contact surface with positive-electrode terminal 14) at that time becomes a temperature (approximately between 150° C. and 300° C. (inclusive), for example) lower than a melting point (about 660° C.) of an aluminum thin plate constituting lead tip 47a. Further, as lead tip 47a is in friction with the surface of positive-electrode terminal 14 in the pressed state, the aluminum oxide layer formed on the joining surface of lead tip 47a is broken and aluminum atoms are exposed to the joining surface. Therefore, solid-phase bonding is not hindered.

With the softening due to the temperature rise as described above, aluminum atoms having high purity that are exposed to the joining surface of lead tip 47a are enlarged. Therefore, the distance with atoms of the metallic material constituting positive-electrode terminal 14 is decreased and a eutectic state is achieved. Consequently, a solid-phase bonding state is achieved in a short time, and firm joining can be realized. In that case, the area of the joining surface between lead tip 47a and positive-electrode terminal 14 is between 0.1 mm² and 3.0 mm² (inclusive), for example, and preferably, larger than or equal to 0.3 mm². Therefore, lead tip 47a and positive-electrode terminal 14 can be joined with sufficient intensity.

Note that in the present embodiment, as a heating means from the outside of positive-electrode lead part 47, an example of laser beam irradiation has been described. However, the present disclosure is not limited thereto. It is possible to perform irradiation by condensing light such as LED, for example. Further, in the case where the lead tip and the terminal are made of same type of metal and solid-phase bonding is easily performed, for example, local heating by a laser beam can be omitted.

After positive-electrode lead part 47 of positive-electrode lead plate 41 is connected to positive-electrode terminal 14 of each battery cell 11 through ultrasonic joining, as for a negative-electrode terminal 15 of battery cell 11, negative-electrode lead part 50 of negative-electrode lead plate 46 can be applied with solid-phase bonding by ultrasonic joining, similarly.

As described above, according to battery module 10 and the method for manufacturing battery module 10 according to the present embodiment, lead plates 41, 46 each formed of an aluminum thin plate can be firmly joined by solid-phase bonding to positive-electrode and negative-electrode terminals 14, 15 of battery cell 11 even between different types of metals to say nothing of same types of metals. Therefore, reliability of battery module 10 is improved, and productivity of battery module 10 is also improved by reduction of the joining time.

Note that the battery module and the method for manufacturing the battery module according to the present disclosure should not be limited to the exemplary embodiment and modification thereof. It is needless to say that various modifications and alterations can be made within the scope of the appended claims of the present application and their equivalents.

1. A method of manufacturing a battery module, the battery module including a plurality of battery cells each having a terminal, and a lead plate having a lead part to be joined to the terminal of each of the plurality of battery cells to electrically connect the battery cells to each other, the lead part being connected to the terminal by solid-phase bonding through ultrasonic joining, the method comprising:
a preparing step of preparing the plurality of the battery cells and the lead plate, the lead part of the lead plate including an aluminum thin plate having aluminum purity higher than or equal to 99.0%, a surface roughness Ra of a joining surface of the lead part to the terminal being less than or equal to 10 μm;
a pressing step of pressing the joining surface of the lead part to the terminal of one of the battery cells by an ultrasonic vibrator;
a vibration step of vibrating the lead part with use of the ultrasonic vibrator; and
a heating step of heating at least the lead part in the lead plate.

2. The method of manufacturing the battery module according to claim 1, wherein a pressing load on the lead part by the ultrasonic vibrator ranges from 1 N to 50 N, and a vibration frequency of the lead part by the ultrasonic vibrator ranges from 60 kHz to 100 kHz.

3. The method of manufacturing the battery module according to claim 1, wherein the lead part that is vibrated in a state of being pressed by the terminal is irradiated with light and is heated locally.

4. The method of manufacturing the battery module according to claim 2, wherein the lead part that is vibrated in a state of being pressed by the terminal is irradiated with light and is heated locally.
